(19) United States
(12) Patent Application Publication
(10) Pub. No.: US 2025/0378106 A1
(43) Pub. Date: Dec. 11, 2025

(54) GENERATING INSIGHTS FOR LARGE DATASETS USING PROMPT GENERATION PROCESSES AND GENERATIVE ARTIFICIAL INTELLIGENCE (AI) MODELS

(71) Applicant: Microsoft Technology Licensing, LLC, Redmond, WA (US)

(72) Inventors: Sathish Kumar MANIVANNAN, Redmond, WA (US); Nan LU, Bellevue, WA (US); Yu KANG, Beijing (CN); Rishika GUPTA, Hyderabad (IN); Yue YAN, Beijing (CN); Zhen XUN, Suzhou (CN); Aniekan Ufot INYANG, Seattle, WA (US); Lin TANG, Bellevue, WA (US); Vinod Ashok MASKE, Hyderabad (IN); Jitendra Jalandar PATIL, Hyderabad (IN); Bhavy KHATRI, Hyderabad (IN); Pallavi GUPTA, Kirkland, WA (US)

(73) Assignee: Microsoft Technology Licensing, LLC, Redmond, WA (US)

(21) Appl. No.: 18/739,031

(22) Filed: Jun. 10, 2024

(51) Int. Cl. G06F 16/35; G06F 16/332; G06F 16/383

(52) U.S. Cl. CPC G06F 16/358; G06F 16/3329; G06F 16/383

(57) ABSTRACT

This disclosure describes a data insights system that implements a framework for generating multimodal insights from large datasets. For example, the data insights system utilizes multiple prompt generation processes paired with one or more generative artificial intelligence (AI) models to efficiently generate accurate visualizations and text insights from a large dataset in response to custom user queries. In particular, the data insights system utilizes different prompt generation processes to intelligently craft targeted generative AI prompts to maximize the efficiency and accuracy of the generative AI insight responses that target answers to custom user queries, rather than providing pre-built dashboards and charts. The data insights system not only provides customized visualizations in response to user queries but also generates and provides insights and summaries that are not intuitively visible. These visual and text insights are presented in a combined interactive interface.

### BACKGROUND

In recent years, significant advancements have been made in both hardware and software domains, particularly in the area of data analytics, including processing large datasets (e.g., “big data”). While many data analytics tools are emerging, several of these tools still require skilled or expert users to correctly use them, accurately interpret results, and make informed data-driven decisions. Indeed, the quality and effectiveness of many data analytics tools heavily rely on users who possess the necessary skills to use complex data analytics tools and have knowledge of the dataset being analyzed. However, due to a lack of specific analytics tool proficiency or understanding of specific data schemas, many users struggle to comprehend data results and analytics obtained from processing large datasets. Furthermore, even with skilled users, numerous existing systems are computationally expensive to run, require substantial resources, and do not consistently produce accurate results. These technical inefficiencies and inaccuracies are further exacerbated by inexperienced users who perform unnecessary operations because existing data analytics tools are excessively complex to use.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of the data insights system that utilizes prompt generation processes and large generative models to create visual and text insights from a target dataset.

FIG. 2 illustrates an example computing environment in which the data insights system is implemented.

FIG. 3 illustrates an example diagram of the data insights system generating visual and text insights from a target dataset.

FIGS. 4A-4B illustrate example diagrams for generating visual insights from the target dataset.

FIGS. 5A-5B illustrate example diagrams for generating text insights from the target dataset.

FIGS. 6A-6B illustrate a graphical user interface flow of providing visual and text insights for a target dataset in response to a user dataset query.

FIG. 7 illustrates another graphical user interface providing visual and text insights for a target dataset in response to a user dataset query.

FIG. 8 illustrates an example series of acts of a computer-implemented method for using one or more generative artificial intelligence (AI) models to generate visualizations and insights from large datasets.

FIG. 9 illustrates example components included within a computer system used to implement the data insights system.

### DETAILED DESCRIPTION

This disclosure describes a data insights system that implements a framework for generating multimodal insights from large datasets. For example, the data insights system utilizes multiple prompt generation processes paired with one or more generative artificial intelligence (AI) models to efficiently generate accurate visualizations and text insights from a large dataset in response to custom user queries. In particular, the data insights system utilizes different prompt generation processes to intelligently craft targeted generative AI prompts to maximize the efficiency and accuracy of the generative AI insight responses that target answers to custom user queries, rather than providing pre-built dashboards and charts. Indeed, the data insights system not only provides customized visualizations (e.g., visual insights) in response to user queries but also generates and provides textual insights and summaries that are not intuitively visible. These visual and text insights are presented in a combined interactive interface.

As mentioned, implementations of the present disclosure provide benefits and solve problems in the art with systems, computer-readable media, and computer-implemented methods that utilize the data insights system to generate visualizations and text insights from a target large dataset. In particular, the data insights system utilizes statistical models and generative AI models to intelligently craft targeted generative AI prompts for a generative AI model to efficiently and accurately process. Furthermore, in response to a user query about a target dataset, the data insights system provides a comprehensive insight response that includes an object and the plain-language insight summary within an interactive interface.

For context, in various implementations, the data insights system works in connection with a data analytics system. For example, the data insights system is part of a data analytics system that can provide instructions or directives for the data analytics system to perform various actions in connection with generating insights for a target dataset. Accordingly, while this document may describe the data insights system performing a given action, in various instances, the data insights system directs the data analytics system to perform the given action.

To illustrate how the data insights system uses one or more generative AI models to generate visualizations and text insights from large datasets, in various implementations, the data insights system (or a data analytics system) generates a database query prompt based on a user query and a target dataset. In addition, the data insights system provides the database query prompt to a generative AI model to generate a database query. Upon receiving a database query, the data insights system (or the data analytics system) executes the database query to obtain selected data from the target dataset and generates a visualization object from the selected data based on the visualization type. The data insights system also generates data attributes and corresponding attribute causes by analyzing the selected data. Next, in various implementations, the data insights system utilizes the generative AI model to generate a plain-language insight summary of the data attributes and the corresponding attribute causes. The data insights system (or the data analytics system) also provides the visualization object and the plain-language insight summary within a user interface in response to the user query.

As described in this disclosure, the data insights system delivers several significant technical benefits in terms of improved accuracy and efficiency compared to existing computer systems that provide data analytics tools. Moreover, the data insights system provides several practical applications that address problems related to improving the efficiency and accuracy of using generative AI models, as well as using various models and processes to generate visual and text insights efficiently.

To elaborate, in various implementations, the data insights system improves the efficiency and accuracy of a generative AI model by generating targeted and directed generative AI prompts using different prompt generation processes. These prompts are used to generate corresponding insight results for custom queries. For example, a first prompt generation process (e.g., a visualization object generator) includes the data insights system generating a database query prompt that includes query parameters for a target dataset, a dynamic example, and a visualization type. The database query prompt along with the inputs allows the generative AI model to efficiently and accurately generate a database query. The data analytics system then executes the database query prompt to efficiently locate and generate a visualization object based on the user query.

By using the generative AI model to generate the database model query to answer the user query instead of using the generative AI model directly, the data insights system achieves more accurate answers. This is because generative AI models still struggle with statistical analysis. Additionally, generative AI models have input token limits that prevent them from considering all of the data in a large dataset when attempting to answer the user query.

Similarly, a second prompt generation process (e.g., an insight generator) determines additional analysis and insights for the user query based on select portions of the target dataset identified in the first prompt generation process and statistical models that provide forecasting and anomaly detection. Furthermore, the second prompt generation process efficiently and accurately determines the reasoning for unexpected outliers in the data. Upon generating insights, including reasons for unexpected results, in response to the user query, the data insights system efficiently utilizes the generative AI model to generate a plain-language summary of the insights. Once again, the data insights system provides a targeted prompt to the generative AI model, ensuring efficient processing and accurate results.

In particular, the inventors tested the accuracy of implementations of the data insights system against various benchmark tests that use generative AI models that were used to perform similar tasks involving the analysis of time series data. In one of these tests, they found that the data insights system achieved 92.65% accuracy compared to a benchmark accuracy of 66.45% for correct trend detection. In another test, the inventors found that the data insights system achieved 94.85% accuracy compared to a benchmark accuracy of 46.15% for correct outlier detection. In an additional test, the inventors found that the data insights system achieved 98.86% accuracy compared to a benchmark accuracy of 74.40% for correct event effect detection. Overall, the data insights system achieved a 97.40% accuracy for correct summary and descriptive statistics.

As illustrated in the preceding discussion, this disclosure uses a variety of terms to describe the features and advantages of one or more described implementations. For example, this disclosure describes the data insights system within the context of a data analytics system and a cloud computing system. As an example, the term “cloud computing system” refers to a network of interconnected computing devices that provide various services and applications to computing devices (e.g., server devices and client devices) inside or outside of the cloud computing system.

As an example, the term “user query” (or simply “query”) refers to data received from a user or a system regarding a target dataset. For example, a user interface provides an interactive dashboard of the data analytics system that includes an input field for a user to provide a user query. In response to receiving a user query, the data insights system (using the data analytics system) provides visual and/or textual summary insights within the interactive interface.

As an example, the term “generative artificial intelligence model” (or “generative AI model”) refers to an artificial intelligence computational system that utilizes deep learning and a large number of parameters (e.g., in the billions or trillions for a large version and fewer for a small version) that are trained on one or more extensive datasets to produce coherent, contextually relevant, and fluently topic-specific outputs (e.g., text and/or images). In many instances, a generative AI model refers to an advanced computational system that uses natural language processing, machine learning, and/or image processing to generate coherent and contextually relevant human-like responses.

Generative AI models have applications in natural language understanding, content generation, text summarization, dialogue systems, language translation, creative writing assistance, image generation, audio generation, and more. A single generative AI model often performs a wide range of tasks by receiving different inputs, such as prompts (e.g., input instructions, rules, example inputs, example outputs, and/or tasks), data, and/or access to data. In response, the generative AI model generates various output formats ranging from one-word answers to long narratives, images and videos, labeled datasets, documents, tables, and presentations.

Moreover, generative AI models are primarily based on transformer architectures to understand, generate, and manipulate human language. Generative AI models can also use other types of architectures such as recurrent neural network (RNN) architecture, long short-term memory (LSTM) model architecture, convolutional neural network (CNN) architecture, or other types of architectures. Examples of generative AI models include generative pre-trained transformer (GPT) models such as GPT-3.5, GPT-4 and GPT-4o, bidirectional encoder representations from transformers (BERT) model, text-to-text transfer transformer models like T5, conditional transformer language (CTRL) models, and Turing-NLG. Other types of generative AI models include sequence-to-sequence models (Seq2Seq), vanilla RNNs, and LSTM networks. In some instances, a generative AI model includes a large language model (LLM), a small language model (SLM) n and a small action model (SAM), which serves as a text-based version of a generative AI model, such as one that receives text prompts and/or generates text outputs. In various implementations, a generative AI model is a multimodal generative model that receives multiple input formats (e.g., text, images, video, data structures) and/or generates multiple output formats.

As an example, the terms “prompt,” “model prompt,” or “generative AI model prompt” refer to a request provided to a large generative image model to create generative AI model output based on plain language guidance prompts. In some instances, the data insights system provides additional inputs or information with a prompt. In various implementations, prompts can include a user-level prompt based on a user query, a system-level prompt with guardrails, and/or a meta-level prompt. These prompts can include specific instructions, additional contextual information, and/or general framing information to ensure that the generative AI model understands the correct context, syntax, and grounding information of the data it is processing. Examples of prompts include database query prompts and a plain-language insight summary prompt, as further described below.

As an example, the term “visualization object” refers to a graphical object that depicts a dataset or a portion of the dataset in a visual form. A visualization object can include a chart, graph, or image. In some implementations, the visualization object is interactive and/or animated.

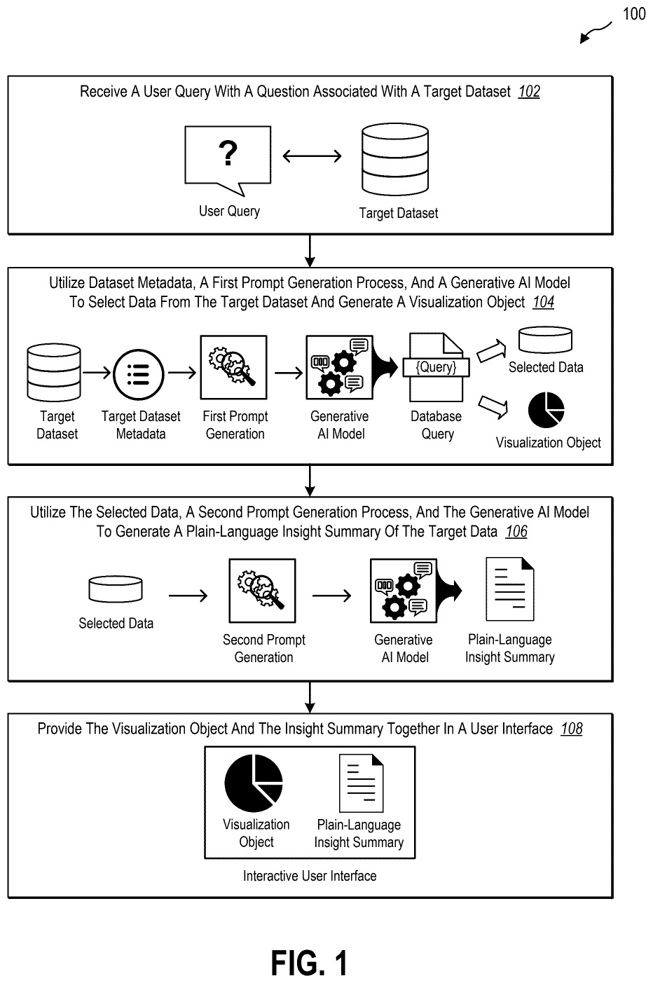

Implementation examples and details of the data insights system are discussed in connection with the accompanying figures, which are described next. For example, FIG. 1 illustrates an overview of the data insights system that utilizes prompt generation processes and large generative models to create visual and text insights from a target dataset according to some implementations. While FIG. 1 provides a high-level overview of the invention, additional details are provided in subsequent figures.

FIG. 1 illustrates a series of acts 100 performed by or following directions from the data insights system. As shown, the series of acts 100 briefly illustrates an example of how the data insights system utilizes prompt generation processes, models, and generative AI models to generate multimodal insights for a target dataset.

The series of acts 100 includes act 102 of receiving a user query with a question associated with a target dataset. For instance, a user is interacting with a target dataset within a data analytics system. The user may have a question regarding the target dataset and can use an input field to submit a user query. The data insights system allows users of any experience or skill level to ask any question associated with the target dataset, ranging from simple to complex questions. Commonly, the user provides a user query using plain language.

Act 104 includes utilizing dataset metadata, a first prompt generation process, and a generative AI model to select data from the target dataset and generate a visualization object. In various implementations, the data insights system identifies metadata for data within the target dataset that may help answer the user query. In addition, the data insights system provides the user query and the metadata to a first prompt generation process, which generates a database query prompt for answering the user query.

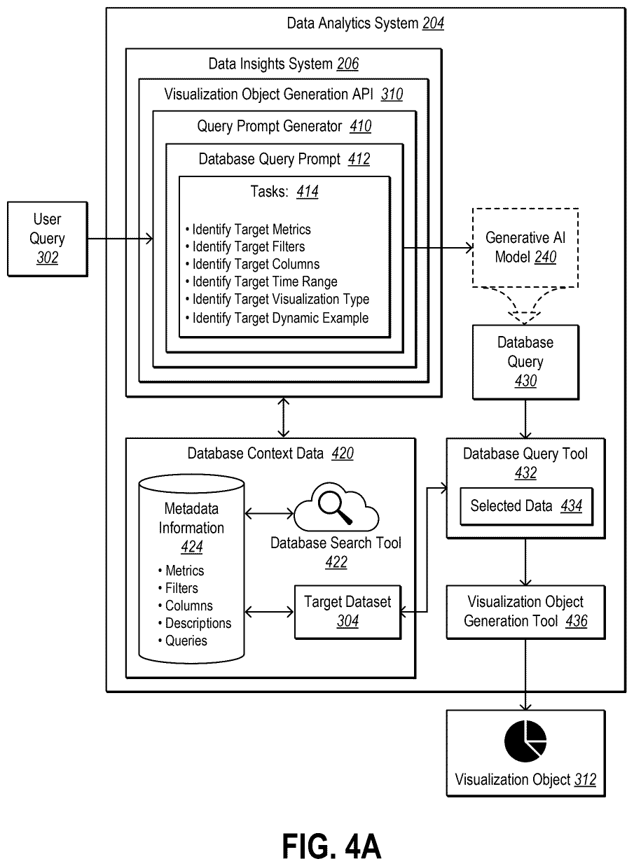

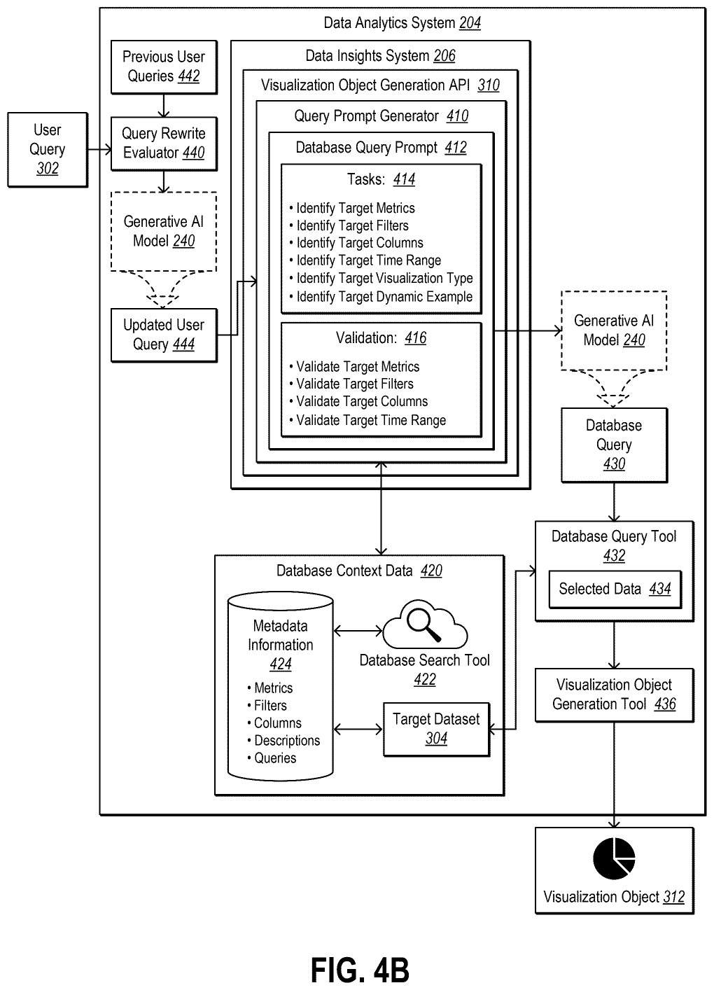

Additionally, as shown, the data insights system provides the database query prompt to a generative AI model that efficiently and accurately generates a database query. By executing the database query, the data insights system quickly and correctly identifies and obtains selected data from the target dataset. For example, the data insights system and/or the data analytics system executes the database query to identify the selected data within the target dataset. Additionally, the data insights system and/or the data analytics system generates a visualization object (e.g., a chart or graph) based on the selected data as it relates to the user query. Further details about the first prompt generation process and generating a visualization object from selected target dataset data are provided in connection with FIGS. 4A-4B below.

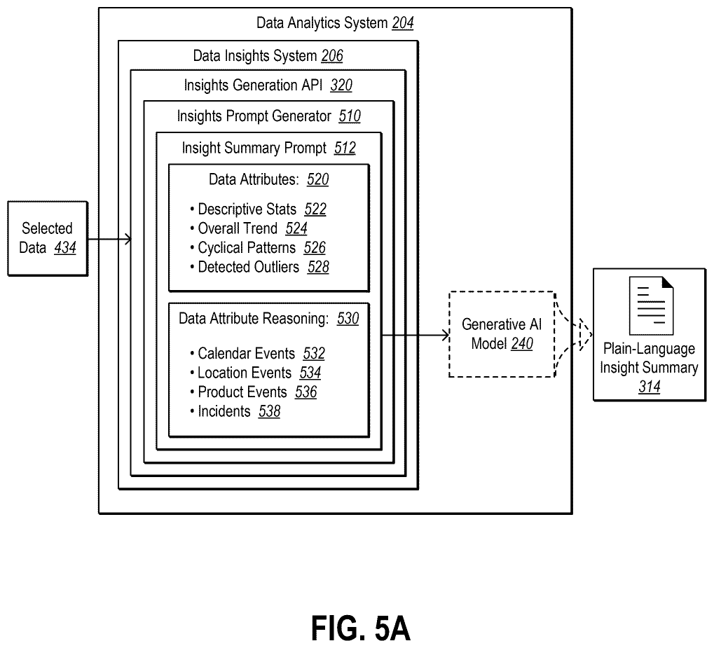

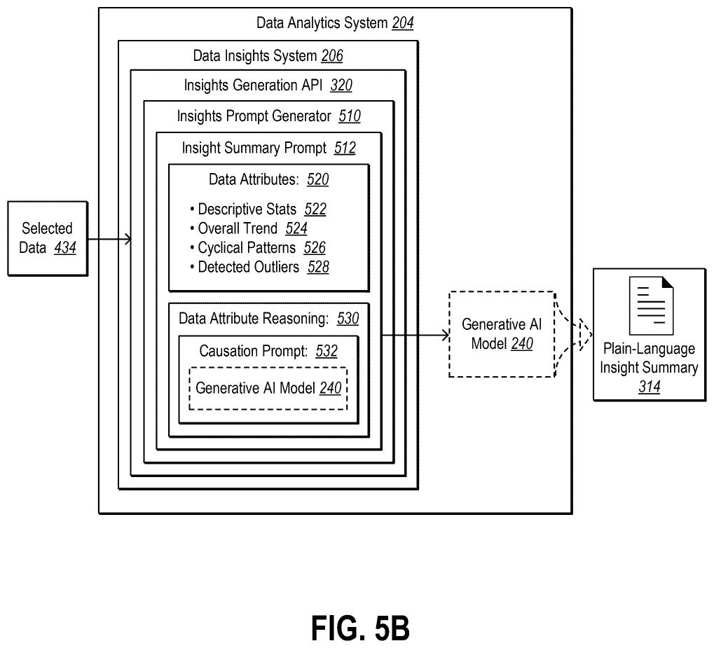

Act 106 includes utilizing the selected data, a second prompt generation process, and the generative AI model to generate a plain-language insight summary of the target dataset. For instance, the data insights system utilizes a second prompt generation process to analyze the selected data for insights, including reasons for outlier results. Furthermore, the second prompt generation process generates a plain-language insight summary prompt, which the generative AI model uses to efficiently generate a plain-language insight summary of the target dataset in response to the user query. Additional details regarding the second prompt generation process and generating a plain-language insight summary from the selected target dataset data and user query are provided in connection with FIGS. 5A-5B below.

Act 108 includes providing the visualization object and the insight summary together in a user interface. For example, if the user query is provided in an interactive user interface provided by the data analytics system, the interactive user interface is updated to include the visualization object and the plain-language insight summary in response to the user query. In this way, the data insights system rewards users who submit user queries with rich and comprehensive visualization insights accompanied by valuable summaries that provide insights into the user queries.

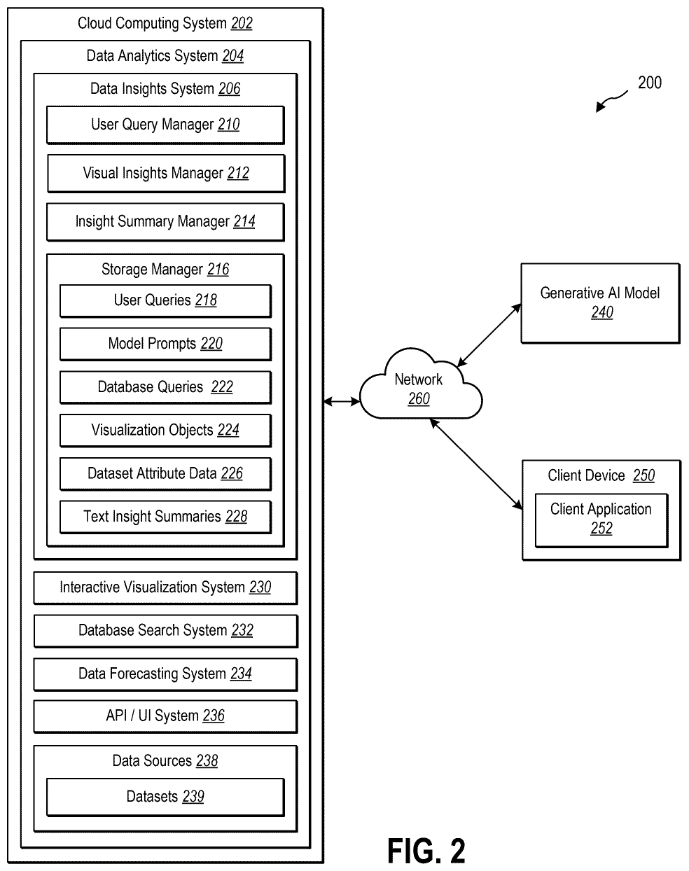

With a general overview in place, additional details are provided regarding the components, features, and elements of the data insights system. To illustrate, FIG. 2 shows an example computing environment where the data insights system is implemented according to some implementations. In particular, FIG. 2 illustrates an example of a computing environment 200 with various computing devices including a cloud computing system 202 associated with a data insights system 206. While FIG. 2 shows example arrangements and configurations of the computing environment 200, the cloud computing system 202, the data insights system 206, and associated components, other arrangements and configurations are possible.

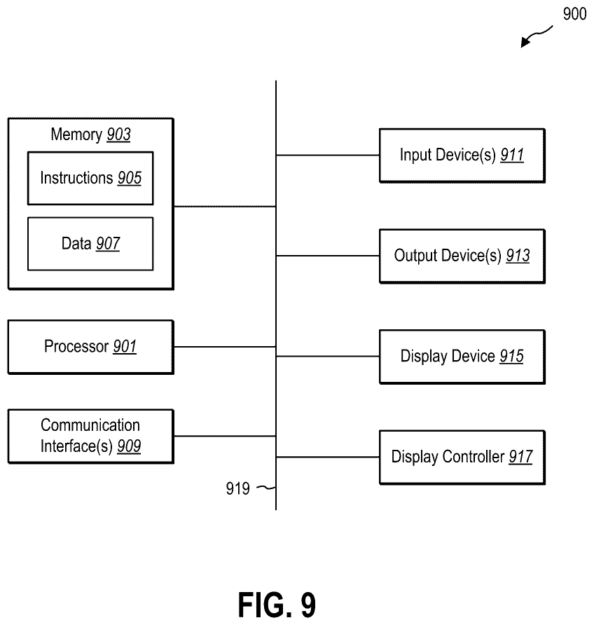

As shown, the computing environment 200 includes a cloud computing system 202 associated with the data insights system 206, a generative AI model 240, and a client device 250 with a client application 252, connected via a network 260. Many of these components may be implemented on one or more computing devices, such as on one or more server devices. Some of these components may be implemented on a personal device (e.g., the generative AI model is a small generative model located on a client device). In various implementations, some of these components (e.g., the generative AI model 240 and the client device 250) represent multiple instances or versions (e.g., the generative AI model 240 represents different instances or versions of a generative model). Further details regarding computing devices are provided below in connection with FIG. 9, along with additional details regarding networks, such as the network 260 shown.

Before describing the components of the cloud computing system 202 including the data insights system 206, other components of the computing environment 200 are first discussed to provide better context when discussing the data insights system 206. As shown, the computing environment 200 includes the generative AI model 240, which creates generative outputs (e.g., AI model outputs) of various types and/or formats and prompt inputs (e.g., AI model prompts). The generative AI model 240 may represent a large and/or small generative AI model. As mentioned, the generative AI model 240 may represent multiple generative models or multiple model instances. In various implementations, the generative AI model 240 generates database queries, data reasonings, and/or plain-language summaries based on responses to receiving corresponding prompts.

As shown, the computing environment 200 includes the client device 250. In various implementations, the client device 250 is associated with a user (e.g., a user client device), such as a user who provides user queries to the cloud computing system 202 (e.g., the data insights system 206 and/or the data analytics system 204). In various instances, the client device 250 includes a client application 252, such as a web browser, mobile application, or another form of computer application for accessing and/or interacting with the cloud computing system 202 and/or the data analytics system 204.

Returning to the cloud computing system 202, as shown, the cloud computing system 202 includes a data analytics system 204. In various implementations, the data analytics system 204 facilitates users to interact with datasets. For example, the data analytics system 204 provides various functions and tools to view, analyze, manipulate, and export large datasets. As shown, the data analytics system 204 includes the data insights system 206 (described below), an interactive visualization system 230, a database search system 232, a data forecasting system 234 (e.g., a data understanding and forecasting), an API/UI system 236, and data sources 238 that include datasets 239.

In various implementations, the interactive visualization system 230 facilitates generating and providing visualization objects associated with the datasets 239. In some implementations, the database search system 232 searches the datasets 239 using search queries to identify dataset metadata and/or selected data. In one or more implementations, the data forecasting system 234 provides data understanding and forecasting to determine trends and descriptive statistics for the data in the datasets 239.

In many implementations, the API/UI system 236 facilitates user interfaces for users to interact with and provide user queries for dataset data. In example implementations, the data sources 238 include one or more of the datasets 239. In some instances, the data sources 238 (and/or other sub-systems of the data analytics system 204) are located outside of the data analytics system 204 within the cloud computing system 202.

As shown, the data analytics system 204 implements the data insights system 206. In some implementations, the data insights system 206 is located on a separate computing device from the data analytics system 204 within the cloud computing system 202 (or apart from the cloud computing system 202). In various implementations, the data analytics system 204 operates without the data insights system 206.

In various implementations, including the illustrated implementation, the data insights system 206 includes various components and elements that are implemented in hardware and/or software. For example, the data insights system 206 includes a user query manager 210, a visual insights manager 212, an insight summary manager 214, and a storage manager 216. The storage manager 216 includes user queries 218, model prompts 220, database queries 222, visualization objects 224, dataset attribute data 226, and text insight summaries 228, among other data associated with the data insights system 206.

In various implementations, the user query manager 210 manages requests and queries from users provided by the client device 250. For example, the user query manager 210 manages user queries 218 related to a target dataset (e.g., from the datasets 239). For example, the user query manager 210 identifies a target dataset directly or indirectly from a user query.

In some implementations, the visual insights manager 212 facilitates generating the visualization objects 224 associated with the user queries 218. For example, the visual insights manager 212 identifies metadata from a target dataset that corresponds to a user query, uses a first prompt generation process to generate a database query prompt (e.g., one of the model prompts 220), provides the database query prompt to the generative AI model 240 to receive a database query (e.g., one of the database queries 222), and executes the database query to obtain selected data from the target dataset and generate a visualization object (e.g., one or more of the visualization objects 224) and selected data.

In various implementations, the insight summary manager 214 facilitates the generation of the text insight summaries 228 with the user queries 218. For example, the insight summary manager 214 obtains the selected data from the target dataset that corresponds to a user query, utilizes a second prompt generation process to generate dataset attribute data 226 (including outlier reasoning) and an insight summary prompt (e.g., one of the model prompts 220), and provides the insight summary prompt to the generative AI model 240 to receive a plain-language insight summary (e.g., one of the text insight summaries 228).

In various implementations, the user query manager 210, the visual insights manager 212, and the insight summary manager 214 may interact with the sub-systems of the data analytics system 204 (e.g., the interactive visualization system 230, the database search system 232, the data forecasting system 234, and the API/UI system 236) to generate the visualization objects 224, the dataset attribute data 226, and the text insight summaries 228, as further described below.

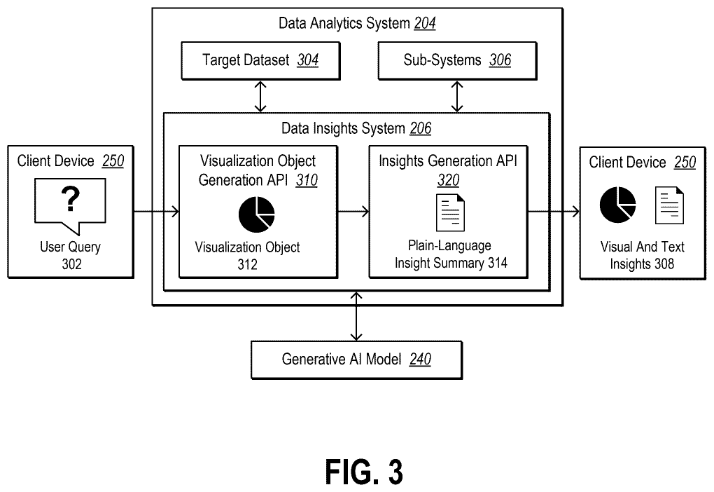

Turning to the next set of figures, FIGS. 3, 4A-4B, and 5A-5B illustrate example block diagrams that focus on different stages of the data insights system to generate multimodal insights in response to a user query. For example, FIG. 3 provides an overview of the data insights system 206 using a visualization object generation API and an insights generation API to generate insights that include a combination of visual objects and text summary insights. FIGS. 4A-4B focus on operations and actions associated with the visualization object generation API while FIGS. 5A-5B focus on operations and actions associated with the insights generation API.

To begin, FIG. 3 illustrates an example diagram of the data insights system generating visual and text insights from a target dataset according to some implementations. As shown, FIG. 3 includes the data insights system 206, the generative AI model 240, and the client device 250, which were introduced above. The data analytics system 204 includes the data insights system 206, a target dataset 304, and sub-systems 306 (e.g., an interactive visualization system, a database search system, a data forecasting system, and an API/UI system).

As shown, the data insights system 206 includes a visualization object generation API 310 and an insights generation API 320. For example, in response to receiving a user query 302 from the client device 250, the visualization object generation API 310 generates the visualization objects 312 from a target dataset 304 using one or more of the sub-systems 306 and the generative AI model 240. Similarly, the insights generation API 320 generates a plain-language insight summary 314 using the target dataset 304, the sub-systems 306, and the generative AI model 240. The data insights system 206 then provides the visualization objects 312 and the plain-language insight summary 314 to the client device 250 as visual and text insights 308.

In various implementations, the visualization object generation API 310 automates identifying the relevant metrics, filters, and dimensions that correspond to the user query within the target dataset 304. In addition, the visualization object generation API 310 facilitates generating customized charts and visuals without requiring users to have a deep technical knowledge of data schemas or visualization tools.

In various implementations, the visualization object generation API 310 also obtains relevant contextual information to provide to the generative AI model 240 as part of obtaining selected data and generating the visualization objects 312. As further described below, the visualization object generation API 310 may use retrieval-augmented generation (RAG) to provide the generative AI model 240 with an external authoritative knowledge base of the target dataset 304. In this way, the data insights system 206 ensures the accuracy and relevance of responses generated by the generative AI model 240. Furthermore, by providing this contextual information in a concise manner, the visualization object generation API 310 also resolves prompt token limit issues.

In one or more implementations, the insights generation API 320 facilitates generating insights that include summaries of descriptive statistics about relevant portions of the target dataset 304, as well as data reasoning that explains the statistics in the form of a plain-language insight summary 314. In various implementations, the plain-language insight summary 314 provides a deeper understanding of the visualization objects 312 by providing executive summaries that highlight trends, outliers, and significant events affecting the data and that are not intuitively recognized.

In one or more implementations, the insights generation API 320 facilitates a multi-phase process that includes a data understanding phase and a data reasoning phase. For example, in the data understanding phase, the overall trend, seasonality, and outliers in the data are identified. In the data reasoning phase, the insights generation API 320 analyzes and correlates the identified data and/or visualization objects 312 with event data to explain outlier data points and provide niche insights.

As mentioned above, FIGS. 4A-4B provide additional details regarding the first prompt generation process and generating a visualization object from selected target dataset data. In particular, FIGS. 4A-4B illustrate example diagrams for generating visual insights from the target dataset according to some implementations.

As shown, FIG. 4A includes the data analytics system 204 receiving the user query 302 and generating the visualization objects 312. The data analytics system 204 includes the data insights system 206 featuring the visualization object generation API 310, database context data 420, a database query tool 432, and a visualization object generation tool 436. FIG. 4A also includes the generative AI model 240, which may reside within the data analytics system 204 or may be located elsewhere (as indicated by being shown in dashed lines).

FIG. 4A provides an example implementation of how the data insights system 206 operates with and directs other components of the data analytics system 204 to generate the visualization objects 312 in response to a user query 302. As shown, the data insights system 206 receives the user query 302. In particular, the visualization object generation API 310 within the data insights system 206 includes a query prompt generator 410 that generates a database query prompt 412 based on implementing tasks 414. In many implementations, the query prompt generator 410 performs the first prompt generation process described above.

In various implementations, the goal of the query prompt generator 410 is to generate a database query prompt 412 that instructs the generative AI model 240 to identify relevant data from the target dataset 304 needed to answer the user query 302 and to have the visualization objects 312 generated from this data. In many instances, while the generative AI model 240 is broadly trained and able to perform a wide range of functions, it lacks the necessary knowledge and context to directly answer the user query or to accurately generate a database query prompt. Accordingly, the query prompt generator 410 provides a database query prompt 412 that includes in-context learning for the generative AI model 240 to accurately and efficiently accomplish the requested tasks. The query prompt generator 410 obtains this context data from the target dataset 304 and other information stored by the data analytics system 204.

To illustrate, the query prompt generator 410 may generate a database query prompt 412 that provides system-level instructions to the generative AI model 240. For instance, the database query prompt 412 begins by stating, “You are an analysis assistant trained in effectively composing dataset queries” and “You are also an expert in translating human questions to SQL language.” In some instances, the database query prompt 412 indicates tools that the generative AI model 240 uses to generate dataset queries. Further, the query prompt generator 410 indicates an output format for the dataset queries (e.g., a valid JSON object).

To obtain the context information that the generative AI model 240 needs, the query prompt generator 410 retrieves the database context data 420 to include in the database query prompt 412. In other words, to create a visualization that satisfies the user query, the query prompt generator 410 should identify the appropriate metrics, filters, time ranges, visualization type, and/or other dimensions required to identify relevant data and generate the visualization objects 312. The query prompt generator 410 uses the database context data 420 to provide this information to the generative AI model 240.

In various implementations, the database context data 420 represents a retrieval-augmented generation (RAG) process for providing in-context learning to the generative AI model 240 such as the database context data 420 provides an authoritative knowledge base beyond the initial training datasets of the generative AI model 240. Additionally, as mentioned above, in various implementations, using RAG also enables the query prompt generator 410 to resolve the token limit issue for prompts (e.g., up to 32 k tokens per API call). Instead, the query prompt generator 410 ensures that the database query prompt 412 is judiciously crafted so that it only includes relevant information for the user query. Moreover, the query prompt generator 410 improves the efficiency of the generative AI model 240 by not including irrelevant information, which can significantly affect the model's performance and accuracy.

As shown, the query prompt generator 410 performs one or more of the tasks 414 in connection with generating the database query prompt 412. The tasks 414 include identifying target metrics, filters, columns, time ranges, visualization types, and dynamic examples, which the generative AI model 240 uses to generate a database query 430 accurately and efficiently. Some or all of the tasks 414 are accomplished by adding database context data 420 to the database query prompt 412.

To illustrate, in various implementations, the query prompt generator 410 provides a request to a database search tool 422 via the data analytics system 204 to identify database context data 420. In response, the database search tool 422 searches the datasets (e.g., the target dataset 304) and other stored information to identify metadata information relevant to the user query. In various implementations, the target dataset 304 includes a mapping of metrics, filters, and columns along with their respective descriptions that the database search tool 422 uses to identify which data is relevant to the user query.

As mentioned above, in various instances, the database search tool 422 searches the target dataset 304 to identify which metrics, filters, and columns would be most useful to answer the user query. In some implementations, the database search tool 422 identifies multiple related metrics and/or filters. Metrics can include saved metrics within the target dataset 304. For example, the database search tool 422 identifies a metric that correlates the information in the user query with a name or description of the metric. In some instances, a metric includes an ad-hoc metric, which is generated by applying a function to one or more columns of existing data. Similarly, the database search tool 422 may select and apply stored filters and/or generate ad-hoc filters to identify the filters that are most relevant to the user query. In cases where the user query asks for an ad hoc or custom metric that does not exist in the target dataset 304, the database search tool 422 may identify the most relevant columns to the user query that can be used to obtain the requested metric.

In various implementations, the database search tool 422 identifies columns of data that satisfy combinations of the metrics and filters to indicate which data in the target dataset 304 could be selected. In some implementations, some or all of the columns include descriptions that specify the type of data being stored and/or what metrics are associated with the data, which the database search tool 422 uses to identify relevant columns.

In various implementations, the database search tool 422 is a cloud computing system-based search tool that retrieves the most relevant metrics, filters, column names, and/or column descriptions based on the user query. For example, the metadata information 424 transforms the user query and the dataset information (e.g., metrics, filters, column names, and column descriptions) into vector embeddings. Then, the database search tool 422 uses an approximate nearest neighbor algorithm to identify the vector embedding that best corresponds to the queried metric by selecting the embedding that most closely aligns with the user query's vector embedding.

Upon identifying data relevant to the user query based on the metrics, filters, columns, and descriptions, the database search tool 422 can generate, lookup, and/or obtain metadata information 424 corresponding to the search results. The database search tool 422 can return the metadata information 424 as database context data 420 to the query prompt generator 410. In some instances, upon fetching relevant metric and filter values based on the user query, in various instances, the query prompt generator 410 adds this metadata to the database query prompt 412.

As shown, the tasks 414 include identifying a target time range and visualization type. In various implementations, the query prompt generator 410 utilizes a time range included in the user query 302 (e.g., the last week, month, 90 days, etc.) Otherwise, in various instances, the query prompt generator 410 selects a default time range. In some instances, the selected default time range is based on the target dataset and/or the identified metric.

In some implementations, the query prompt generator 410 similarly selects a visualization type. For example, if the user query 302 does not include or specify a visualization type, the query prompt generator 410 may select one or more default types. In various instances, the visualization type is based on the type of insights being requested in the user query.

As shown, the tasks 414 also include identifying a dynamic example. In various implementations, the query prompt generator 410 selects the dynamic example by analyzing the user query 302 to determine a context type. Then, based on the context type, the query prompt generator 410 determines an example from a collection of examples. In one or more implementations, the query prompt generator 410 matches the user query 302 to a list of questions to identify a corresponding dynamic example. By providing a dynamic example, the database query prompt 412 efficiently guides the generative AI model 240 to generate an analogous and accurate response.

Upon generating the database query prompt 412, the query prompt generator 410 provides the AI model prompt to the generative AI model 240 for processing. Following the instructions, provided metadata, and dynamic examples, the generative AI model 240 generates a database query 430 to search the target dataset 304 and select the data needed to answer the user query 302. In some instances, the generative AI model 240 converts the pseudocode request and metadata in the accurate and efficient database query prompt into the proper syntax for searching the target dataset 304.

In various implementations, the database query 430 includes instructions for the data analytics system 204 to identify and select the correct data to answer the user query 302. Additionally, the database query 430 includes instructions for the data analytics system 204 to generate a visualization object of the identified visualization type from the selected data. In some implementations, the data insights system 206 requests the data analytics system 204 to generate a visualization object when data from the target dataset 304 is selected.

As shown, the database query 430 is provided to the database query tool 432. For example, the data insights system 206 provides the database query 430 directly to the database query tool 432 or via the generative AI model 240. In some instances, the database query tool 432 executes the database query 430 against the target dataset 304 to identify the selected data 434 needed to answer the user query 302. For example, the database query tool 432 performs the search commands included in the database query 430 to identify and/or apply the relevant metrics, filters, columns, and database commands required to extract the selected data 434. In some instances, the selected data 434 is stored as time series data in a data structure file (e.g., a JSON file).

In addition, the visualization object generation tool 436 of the data analytics system 204 generates the visualization objects 312 based on the selected data 434 and the user query 302. The data insights system 206 provides the selected data 434 and/or the user query 302 directly or indirectly to the visualization object generation tool 436, which generates the visualization objects 312.

FIG. 4B expands upon the implementations of FIG. 4A. For example, FIG. 4B includes a query rewrite evaluator 440 within the data analytics system 204. In some implementations, the query rewrite evaluator 440 is part of the data insights system 206 and/or visualization object generation API 310.

In one or more implementations, the data insights system 206 determines whether the user query 302 has previously been asked or submitted with the same or a similar question. In these implementations, the data insights system 206 utilizes the query rewrite evaluator 440 to compare the user query 302 to previous user queries 442. When previously asked, the query rewrite evaluator 440 may provide the user query 302, the previous user queries 442, and a query rewrite prompt to the generative AI model 240 to generate an updated user query 444 that includes context, responses, and/or other information from the previous occurrences. The data insights system 206 then receives the updated user query 444 and generates the visualization objects 312 following the approaches and techniques described above.

To elaborate, the user query may ask about a particular trend or metric for the target dataset 304 over the past week. If asked on different days, then the corresponding visualization objects will change. However, the data insights system 206 may still use the previous user query contexts to generate a more robust and complete version of the updated user query 444.

FIG. 4B also adds validation 416 to the query prompt generator 410. For example, before providing the database query prompt 412 to the generative AI model 240, the query prompt generator 410 may validate the identified target information to ensure that the metrics, filters, columns, and time range include relevant data. If validation fails, the query prompt generator 410 can repeat the process of obtaining database context data 420 from the target dataset 304 until metadata information 424 relevant to the user query 302 (or updated user query 444) is included in the database query prompt 412. In some implementations, the query prompt generator 410 automatically updates a query parameter that does not initially pass validation until it passes validation.

As mentioned above, FIGS. 5A-5B provide additional details regarding the second prompt generation process and generating a plain-language insight summary from the selected target dataset and user query. In particular, FIGS. 5A-5B illustrate example diagrams for generating text insights from the target dataset according to some implementations.

As shown in FIG. 5A, the data analytics system 204 receives the selected data 434 and generates the plain-language insight summary 314. The data analytics system 204 includes the data insights system 206 featuring the insights generation API 320. FIG. 5A also includes the generative AI model 240, which may reside within the data analytics system 204 or may be located elsewhere (as indicated by being shown in dashed lines). Additionally, the generative AI model 240 shown in FIG. 5A may be the same or a different version or instance of the generative AI model 240 included in FIG. 4A.

FIG. 5A provides an example implementation of how the data insights system 206 operates with and directs other components of the data analytics system 204 to generate and display visual and text insights in response to a user query 302. As shown, the visualization objects 312 within the data insights system 206 includes an insights prompt generator 510 that generates an insights summary prompt 512 based on data attributes 520 and data attribute reasoning 530. In many implementations, the prompt generator 510 performs the second prompt generation process described above.

In various implementations, the prompt generator 510 analyzes the selected data 434 to identify data attributes 520 including descriptive stats 522 (e.g., minimums, maximums, standard deviations), an overall trend 524 (e.g., increasing or decreasing trends), cyclical patterns 526 (e.g., weekdays and weekends), and detected outliers 528 (e.g., data points and time periods with unexpected increase or decreases). For example, the prompt generator 510 uses one or more statistical analysis tools to analyze time series data in the selected data 434 to determine the data attributes 520.

In various implementations, the prompt generator 510 utilizes a data forecasting model, tool, or system to determine some of the data attributes 520. For example, using a data forecasting tool, the query prompt generator 410 determines the overall trend 524, cyclical patterns 526 (e.g., seasonal shifts), and detected outliers 528 (e.g., anomalies) within the selected data 434. In some implementations, the data forecasting model (e.g., a data understanding and forecasting model) uses current data trends, statistics, and patterns to understand the data as well as predict future data points and data behaviors. For instance, the data forecasting tool analyzes the selected data 434 to identify trend changes, seasonality, outliers, and holiday effects in the data.

In one or more implementations, the data forecasting tool determines the data attributes 520 based on a trend function that models non-periodic changes in the values of time series data, periodic changes (e.g., weekly and yearly seasonality) in the time series data values, and holiday effects in the time series data values that occur on potentially irregular schedules over one or more days. In some instances, the data forecasting tool also uses an error term to factor in idiosyncratic changes not accommodated by the model.

In some implementations, the prompt generator 510 configures the data forecasting tool to establish a baseline (e.g., by excluding event data). In some implementations, the prompt generator 510 determines the overall trend 524 by analyzing a trend component from decomposed time series data to identify continuous periods of increase and decrease. In various implementations, the prompt generator 510 determines the cyclical patterns 526 by evaluating weekly, monthly, and yearly seasonality patterns by examining relative contributions of seasonality values compared to trends and holidays and classifying data as part of a seasonality pattern if it meets a threshold (e.g., the seasonality contribution is greater than 5%). In one or more implementations, the prompt generator 510 determines the detected outliers 528 using a confidence interval of a fitted model of the data forecasting tool, where points lying outside the confidence interval are classified as outliers.

With the data attributes 520, in some instances, the prompt generator 510 determines data attribute reasoning 530 to provide additional reasons and explanations for unexpected data attributes. In particular, the data attribute reasoning 530 seeks to explain the logic, causes, and implications behind trends and outliers of the data attributes 520 (e.g., why the trends or outliers occurred).

In various implementations, the prompt generator 510 determines the data attribute reasoning 530 by correlating the data attributes 520 with event and incident data. For example, the prompt generator 510 determines data attribute reasoning 530 by correlating calendar events 532 (e.g., holidays), location events 534 (e.g., local, national, or world events), product events 536 (e.g., product launches or shipped products), incidents 538 (e.g., from website incidents to pandemics), and/or other occurrences with portions of the data attributes 520. In this way, the prompt generator 510 explains why the selected data 434 has a particular attribute or outlier.

Indeed, in various implementations, the prompt generator 510 provides key information and insights for the selected data 434, such as the overall trends, whether are increasing or decreasing, during what time ranges there are there peaks and dips, and the reasons behind the different patterns in the data.

In various implementations, the prompt generator 510 determines the data attribute reasoning 530 by re-running the data forecasting tool with a refined baseline that includes event data to capture the effects of the events. In some instances, the prompt generator 510 determines the calendar events 532 of the data attribute reasoning 530 by identifying periods with a non-zero holiday effect component and calculating an average event effect by assessing the relative contributions of the event component to the overall time series and pinpointing significant peaks and dips during these periods. In one or more implementations, the prompt generator 510 determines unexplained outliers by applying the confidence interval approach for the detected outliers 528 described above with the data attributes 520, focusing on outliers that cannot be explained by events and incidents.

Upon generating the data attributes 520 and the data attribute reasoning 530, in various implementations, the prompt generator 510 adds this data to the summary prompt 512 along with instructions to generate the plain-language insight summary and provides the summary prompt 512 to the generative AI model 240. In response, the generative AI model 240 generates the plain-language insight summary 314 that includes a natural language response of the data attributes 520 and/or the data attribute reasoning 530 correlating to the selected data 434 and the visualization objects. Indeed, the generative AI model 240 converts syntax-heavy statistics into a text summary that is easy to read and comprehend.

While the above process corresponds to generating visualization objects 312 and a plain-language insight summary 314 for a target dataset and/or a single line of data, in various implementations, the data insights system 206 performs similar processing for multiple data lines. In these instances, the data insights system 206 can provide data analysis and data reasoning found in multiple data lines over the same time period.

FIG. 5B provides a different implementation compared to FIG. 5A. For instance, in FIG. 5B, the events in the data attribute reasoning 530 are replaced with a causation prompt and a generative AI model 240. In various implementations, the data insights system 206 utilizes the generative AI model 240 to determine the data attribute reasoning 530 for the data attributes 520. In some instances, the prompt generator 510 makes multiple calls to the generative AI model 240 to determine the reasoning behind different sections of the data attributes 520

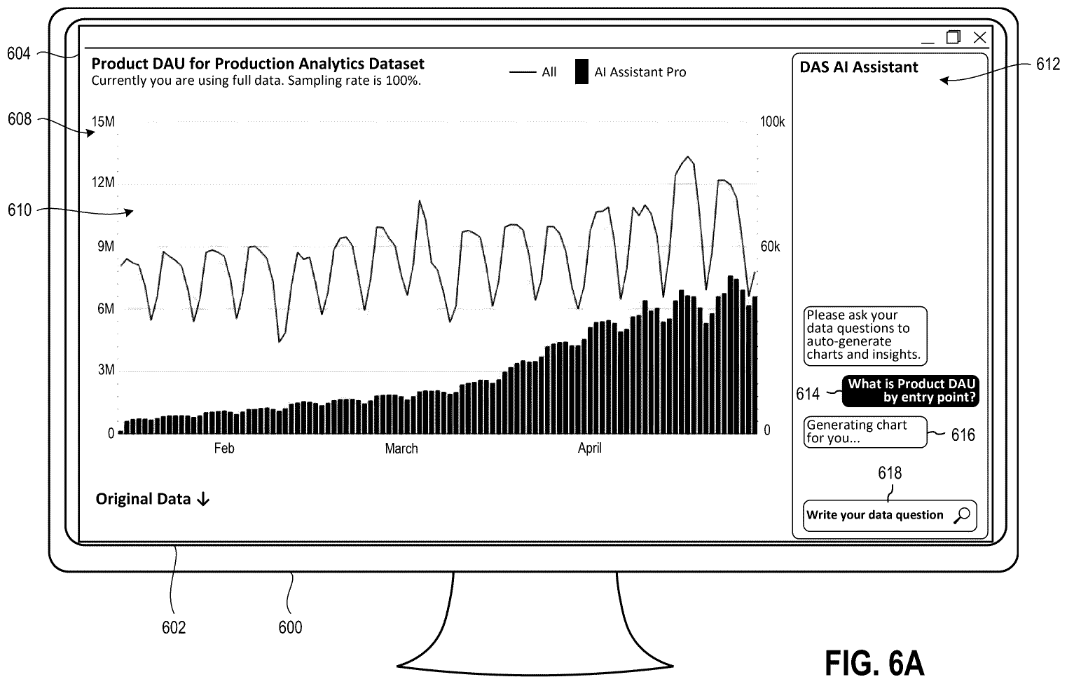

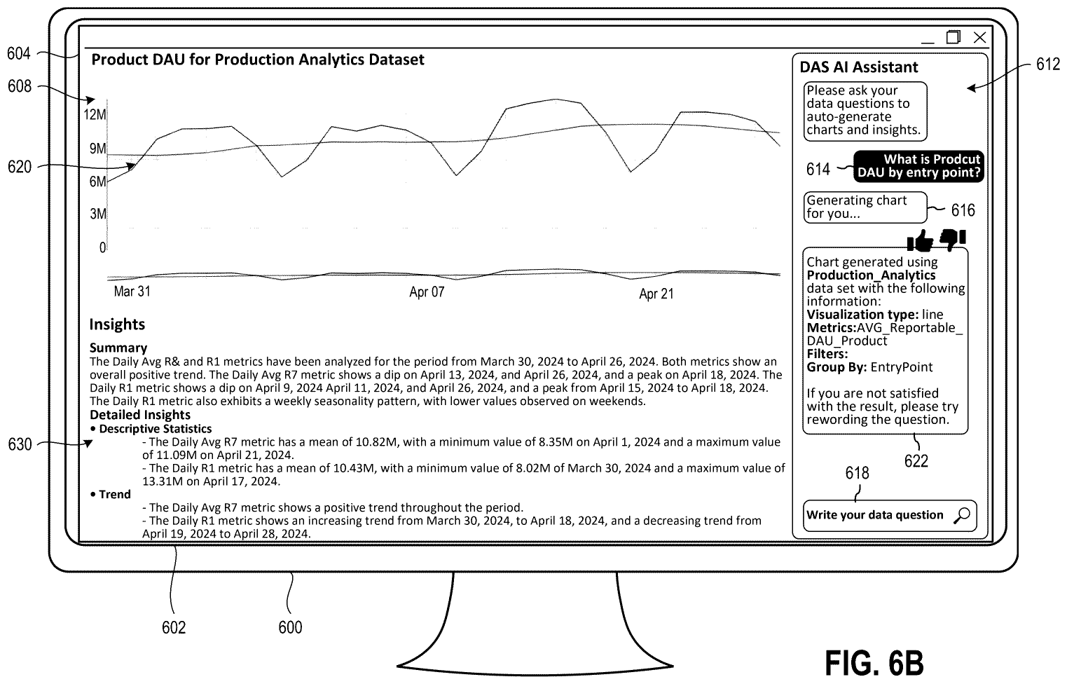

FIGS. 6A-6B illustrate a graphical user interface flow of providing visual and text insights for a target dataset in response to a user dataset query according to some implementations. As shown, FIGS. 6A-6B include a client device 600 that includes a graphical user interface 602 and a client application 604. For example, the client device 600 and the client application 604 represent the client device 250 and the client application 252 introduced above. In addition, the client application 604 is associated with a data analytics system (“DAS”) that includes an interactive user interface 608, which shows a dashboard for providing data and analytics.

FIG. 6A displays a target dataset 610 within the interactive user interface 608 as well as a dataset query tool 612 where a user can ask questions about the target dataset. As shown, the dataset query tool 612 includes a text input field 618 at the bottom where the data insights system 206 can accept user queries. The dataset query tool 612 also includes a message thread that includes a user query 614 and an initial response 616 indicating that the data insights system 206 is processing the user query.

As described above, the data insights system 206 facilitates the generation of one or more visualization objects and a corresponding plain-language insight summary for the target dataset based on the user query. To illustrate, FIG. 6B shows the interactive user interface 608 of the client application 604 updating to display a visualization object 620 and a plain-language insight summary 630. In some implementations, the data insights system 206 provides multiple visualization objects of different visualization types in response to the user query.

In various implementations, the plain-language insight summary 630 includes a high-level, plain-language summary of the target data set reflected in the visualization object 620, including averages, overall trends, corresponding time ranges, etc. In addition, the plain-language insight summary 630 can include a plain-language summary of the descriptive statistics, trends, cyclical patterns, and outliers along with reasons, insights, and observations for each of these summaries.

In addition, FIG. 6B shows the dataset query tool 612 updating to show an additional response that includes the data attributes 622 used by the data insights system 206 to generate the visualization object 620 and the plain-language insight summary 630. The dataset query tool 612 also allows a user to ask follow-up questions, such as requesting to refine the visualization object to a particular filter (e.g., from nationwide data to a particular region). The data insights system 206 can use similar processes and techniques as described above to answer the follow-up questions. However, in some instances, the data insights system 206 may allow the generative AI models to keep the previous prompts and responses in their memory to use as additional context in generating new database prompt queries and plain language responses when answering the follow-up questions.

In some implementations, the data insights system 206 can generating a set of visualization objects (e.g., charts) from the user query or a set of user queries. For instance, the data insights system 206 cyclically generates different sets of visual insights and corresponding text insights with summaries with which to populate an interactive user interface dashboard. In this way, in response to one or a few user queries, the data insights system 206 provides a wealth of rich, useful, and interactive information to a user.

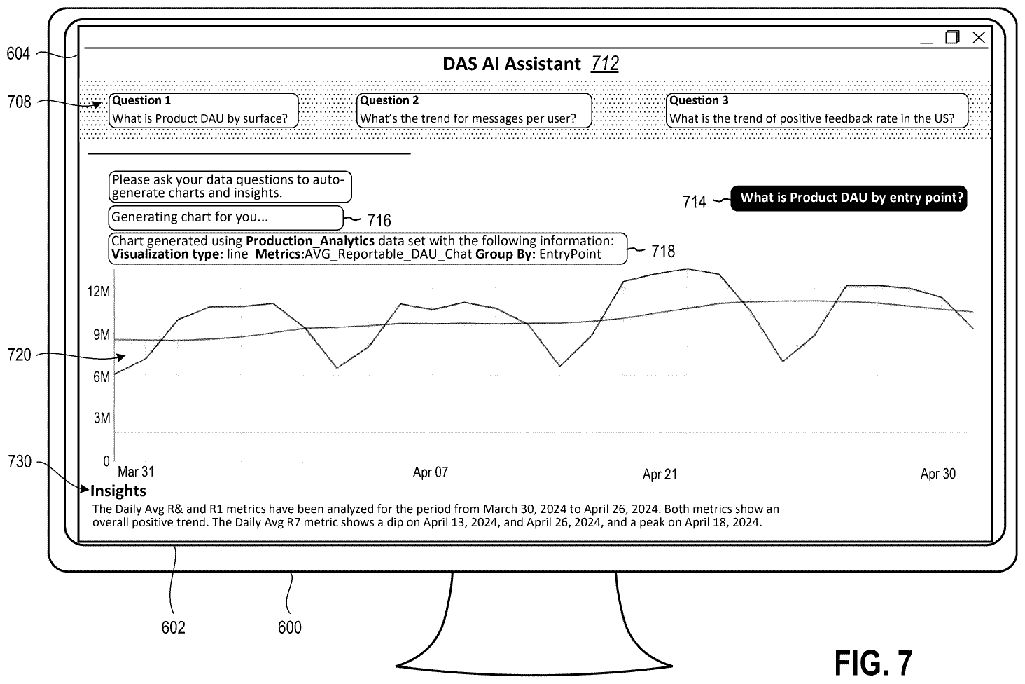

FIG. 7 illustrates another graphical user interface for providing visual and textual insights for a target dataset in response to a user dataset query according to some implementations. FIG. 7 also includes the client device 600, the graphical user interface 602, and the client application 604, which represent a data analytics system (“DAS”).

The client application 604 displays another example of a dataset query tool 712. As shown, the dataset query tool 712 includes a message thread that includes a user query 714 requesting that the data insights system 206 generate visual and corresponding plain-language insights for a target dataset. In some implementations, the data insights system 206 can infer the target dataset from the user query. The message thread also includes the initial response 716 from the data insights system 206.

Additionally, the message thread includes a response 718 that includes data attributes identified from the user query 714 and used to generate the visualization object 720. The message thread also includes the plain-language insight summary 730, which corresponds to the visualization object 720 and the user query 714.

FIG. 7 also includes recommended user queries 708. In various implementations, the data insights system 206 provides one or more of the recommended user queries 708 for the user to select. In some instances, the recommended user queries 708 are based on characteristics of the user (e.g., job role or project assignments), previous queries requested by the user, and/or previous queries submitted by similar users.

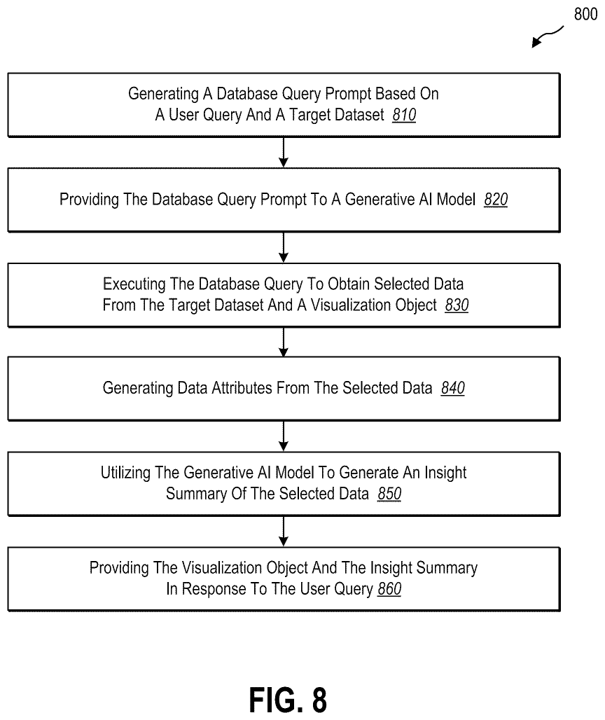

Turning now to FIG. 8, this figure illustrates an example series of acts of a computer-implemented method for using one or more generative artificial intelligence (AI) models to generate visualizations and text insights from large datasets according to some implementations. While FIG. 8 illustrates acts according to one or more implementations, alternative implementations may omit, add to, reorder, and/or modify any of the acts shown.

The acts in FIG. 8 can be performed as part of a method (e.g., a computer-implemented method). Alternatively, a computer-readable medium can include instructions that, when executed by a processing system with a processor, cause a computing device to perform the acts in FIG. 8. In some implementations, a system (e.g., a processing system comprising a processor) can perform the acts in FIG. 8. For example, the system includes a processing system and a computer memory including instructions that, when executed by the processing system, cause the system to perform various actions or steps.

As shown, the series of acts 800 includes act 810 of generating a database query prompt based on a user query and a target dataset. For instance, in example implementations, act 810 involves generating, by a data analytics system, a database query prompt based on a user query and a target dataset, wherein the database query prompt includes query parameters identified for the target dataset, a dynamic example, and a visualization type.

In various implementations, act 810 includes receiving a user query associated with a target dataset and determining that the user query was previously received. In some instances, in response to a data analytics system determining that the user query was previously received, act 810 also includes using a generative AI model to generate an updated user query to include context information from a previous instance of the user query. In these implementations, the user query in act 810 above represents the updated user query.

In various implementations, act 810 includes determining, by the data analytics system, that the user query was previously received, identifying context information associated with a previous instance of the user query, and using the generative AI model to generate an updated user query to include the context information from the previous instance of the user query. In some instances, generating the database query prompt is based on the updated user query. In various implementations, act 810 includes determining the dynamic example by comparing the user query to a set of user queries to identify a correlated user query, identifying an example associated with the correlated user query, and selecting the example as the dynamic example to include in the database query prompt. In various implementations, act 810 includes determining whether the user query includes a time range and including the time range in the database query prompt based on the user query including a time range or including a default time range in the database query prompt based on the user query not including a time range.

In some implementations, the query parameters include a metric, a time range, and a data location for data within the target dataset that corresponds to the user query. In various implementations, act 810 includes using the user query with a database search tool to identify the metric and the data location from the target dataset. In some implementations, using the database search tool includes searching metadata information of the target dataset to identify the metric and the data location from the target dataset. In some cases, the metadata information includes a column name, a column description, and a column query of a column associated with the data within the target dataset that corresponds to the user query.

In various implementations, act 810 includes generating the database query prompt by validating the query parameters and automatically updating a query parameter that does not initially pass (e.g., fails) validation. In various implementations, act 810 includes providing an interactive interface within the data analytics system that enables the selection of the target dataset and receiving the user query within a text query field associated with the interactive interface.

As further shown, the series of acts 800 includes act 820 of providing the database query prompt to a generative AI model. For instance, in example implementations, act 820 involves providing the database query prompt to a generative AI model to generate a database query. In some implementations, act 820 is based on the query parameters identified for the target dataset, the dynamic example, and the visualization type. In various implementations, the database query includes instructions for the data analytics system to identify the selected data within the target dataset and generate the visualization object from the selected data based on the visualization type.

As further shown, the series of acts 800 includes act 830 of executing the database query to obtain selected data from the target dataset and a visualization object. For instance, in example implementations, act 830 involves executing, by the data analytics system, the database query to obtain selected data from the target dataset and to generate a visualization object from the selected data based on the visualization type. In various implementations, act 830 includes the data analytics system using a visualization generation tool to generate the visualization object from the selected data.

As shown further, the series of acts 800 includes act 840 of generating data attributes from the selected data. For instance, in example implementations, act 840 involves generating data attributes and their corresponding attribute causes based on analyzing the selected data. In various implementations, in connection with act 840, generating the data attributes includes using a data forecasting tool to determine overall trends, cyclical patterns, and anomalies within the selected data. In some implementations, generating the corresponding attribute causes includes correlating one or more events to the data attributes to determine the attribute causes of the data attributes. In various implementations, generating the corresponding attribute causes includes using the generative AI model to determine attribute causes of the data attributes based on one or more events and the data attributes.

As further shown, the series of acts 800 includes act 850 of utilizing the generative AI model to generate an insight summary of the selected data. For instance, in example implementations, act 850 involves utilizing the generative AI model to generate a plain-language insight summary of the data attributes and the corresponding attribute causes. In various implementations, in connection with act 850, generating the plain-language insight summary using the generative AI model includes generating a plain-language insight summary prompt that instructs the generative AI model to convert the data attributes and the corresponding attribute causes into natural language text, and providing the plain-language insight summary prompt to the generative AI model. In some implementations, the generative AI model represents multiple and/or different generative AI models. For example, the database query prompt is provided to a first generative AI model, and the insight summary prompt is provided to a second, different generative AI model.

As further shown, the series of acts 800 includes act 860 of providing the visualization object and the insight summary in response to the user query. For instance, in example implementations, act 860 involves providing, by the data analytics system, the visualization object and the plain-language insight summary within a user interface in response to the user query.

In various implementations, in connection with act 860, providing the visualization object and the plain-language insight summary within the user interface includes generating an interactive interface that includes the visualization object and the plain-language insight summary and displaying the interactive interface within a user interface of the data analytics system.

FIG. 9 illustrates certain components that may be included within a computer system 900. The computer system 900 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 900 represents one or more of the client devices, server devices, or other computing devices described above. For example, the computer system 900 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 900 includes a processing system including a processor 901. The processor 901 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 901 may be referred to as a central processing unit (CPU) and may cause computer-implemented instructions to be performed. Although the processor 901 shown is just a single processor in the computer system 900 of FIG. 9, in an alternative configuration, a combination of processors (e.g., an ARM and DSP) could be used.

The computer system 900 also includes memory 903 in electronic communication with the processor 901. The memory 903 may be any electronic component capable of storing electronic information. For example, the memory 903 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 905 and the data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during the execution of the instructions 905 by the processor 901.

A computer system 900 may also include one or more communication interface(s) 909 for communicating with other electronic devices. The one or more communication interface(s) 909 may be based on wired communication technology, wireless communication technology, or both. Some examples of the one or more communication interface(s) 909 include a Universal Serial Bus (USB), an Ethernet adapter, a wireless adapter that operates according to an Institute of Electrical and Electronics Engineers (IEEE) 902.11 wireless communication protocol, a Bluetooth® wireless communication adapter, and an infrared (IR) communication port.

A computer system 900 may also include one or more input device(s) 911 and one or more output device(s) 913. Some examples of the one or more input device(s) 911 include a keyboard, mouse, microphone, remote control device, button, joystick, trackball, touchpad, and light pen. Some examples of the one or more output device(s) 913 include a speaker and a printer. A specific type of output device that is typically included in a computer system 900 is a display device 915. The display device 915 used with implementations disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For clarity, the various buses are illustrated in FIG. 9 as a bus system 919.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

1. A computer-implemented method for using one or more generative artificial intelligence (AI) models to generate visualizations and text insights from large datasets, comprising:
generating, by a data analytics system, a database query prompt based on a user query and a target dataset, wherein the database query prompt includes query parameters identified for the target dataset, a dynamic example, and a visualization type for generating a visualization object from selected data obtained from a database query;
providing the database query prompt to a generative AI model to generate the database query based on the query parameters identified for the target dataset and the visualization type for generating the visualization object;
executing, by the data analytics system, the database query to:
obtain the selected data from the target dataset; and
generate the visualization object from the selected data according to the visualization type;
generating data attributes and corresponding attribute causes based on analyzing the selected data;
utilizing the generative AI model to generate a plain-language insight summary of the data attributes and the corresponding attribute causes; and
providing, by the data analytics system, the visualization object and the plain-language insight summary within a user interface in response to the user query.

2. The computer-implemented method of claim 1, further comprising:
determining, by the data analytics system, that the user query was previously received;
identifying context information associated with a previous instance of the user query; and
using the generative AI model to generate an updated user query to include the context information from the previous instance of the user query,
wherein generating the database query prompt is based on the updated user query.

3. The computer-implemented method of claim 1, wherein:
providing the database query prompt instructs the generative AI model to generate the database query based on the query parameters identified for the target dataset, the dynamic example, and the visualization type; and
the database query includes instructions for the data analytics system to identify the selected data within the target dataset and generate the visualization object from the selected data based on the visualization type.

4. The computer-implemented method of claim 1, further comprising determining the dynamic example by:
comparing the user query to a set of user queries to identify a correlated user query;
identifying an example associated with the correlated user query; and
selecting the example as the dynamic example to include in the database query prompt.

5. The computer-implemented method of claim 1, wherein generating the database query prompt includes:
determining whether the user query includes a time range;
based on the user query including a time range, including the time range in the database query prompt; and
based on the user query not including a time range, including a default time range in the database query prompt.

6. The computer-implemented method of claim 1, wherein the query parameters include a metric, a time range, and a data location for data within the target dataset that corresponds to the user query.

7. The computer-implemented method of claim 6, wherein generating the query parameters includes using the user query with a database search tool to identify the metric and the data location from the target dataset.

8. The computer-implemented method of claim 7, wherein using the database search tool includes searching metadata information of the target dataset to identify the metric and the data location from the target dataset, wherein the metadata information includes a column name, a column description, and a column query of a column associated with the data within the target dataset that corresponds to the user query.

9. The computer-implemented method of claim 1, wherein generating the database query prompt includes validating the query parameters and automatically updating a query parameter that does not initially pass validation.

10. The computer-implemented method of claim 1, wherein the data analytics system includes a visualization generation tool to generate the visualization object from the selected data.

11. The computer-implemented method of claim 1, wherein generating the data attributes comprises using a data forecasting tool to determine overall trends, cyclical patterns, and outliers within the selected data.

12. The computer-implemented method of claim 11, wherein generating the corresponding attribute causes includes correlating one or more events to the data attributes to determine attribute causes of the data attributes.

13. The computer-implemented method of claim 11, wherein generating the corresponding attribute causes includes using the generative AI model to determine attribute causes of the data attributes based on one or more events and the data attributes.

14. The computer-implemented method of claim 1, wherein generating the plain-language insight summary using the generative AI model includes:
generating a plain-language insight summary prompt that instructs the generative AI model to convert the data attributes and the corresponding attribute causes into natural language text; and
providing the plain-language insight summary prompt to the generative AI model.

15. The computer-implemented method of claim 1, wherein providing the visualization object and the plain-language insight summary within the user interface includes:
generating a custom-generated interactive interface that includes:
a custom-generated visualization object generated from the selected data and the user query; and
the plain-language insight summary; and
displaying the custom-generated interactive interface within a user interface of the data analytics system.

16. A system comprising:
a processing system; and
a computer memory comprising instructions that, when executed by the processing system, cause the system to perform operations of:
generating, by a data analytics system, a database query prompt based on a user query and a target dataset, wherein the database query prompt includes query parameters identified for the target dataset, a dynamic example, and a visualization type for generating a visualization object from selected data obtained from a database query;
providing the database query prompt to a first generative AI model to generate the database query based on the query parameters identified for the target dataset and the visualization type for generating the visualization object;
executing, by the data analytics system, the database query to;
obtain the selected data from the target dataset; and
generate the visualization object from the selected data according to the visualization type;
generating data attributes and corresponding attribute causes based on analyzing the selected data;
utilizing a second generative AI model to generate a plain-language insight summary of the data attributes and the corresponding attribute causes; and
providing, by the data analytics system, the visualization object and the plain-language insight summary within a user interface in response to the user query.

17. The system of claim 16, wherein the first generative AI model and the second generative AI model are different generative AI models.

18. The system of claim 16, further comprising:
providing an interactive interface within the data analytics system that enables a selection of the target dataset; and
receiving the user query within a text query field associated with the interactive interface.

19. The system of claim 16, wherein generating the query parameters includes using the user query with a database search tool to identify a metric, a time range, and a data location for data within the target dataset that corresponds to the user query.

20. A computer-implemented method for using one or more generative artificial intelligence (AI) models to generate visualizations and text insights from large datasets, comprising:
in response to a data analytics system determining that a user query associated with a target dataset was previously received, using a generative AI model to generate an updated user query to include context information from a previous instance of the user query;
generating, by the data analytics system, a database query prompt based on the updated user query and the target dataset, wherein the database query prompt includes query parameters identified for the target dataset, a dynamic example, and a visualization type for generating a visualization object from selected data obtained from a database query;
providing the database query prompt to the generative AI model to generate the database query based on the query parameters identified for the target dataset and the visualization type for generating the visualization object;
executing, by the data analytics system, the database query to:
obtain the selected data from the target dataset; and
generate the visualization object from the selected data according to the visualization type;
generating data attributes and corresponding attribute causes based on analyzing the selected data;
utilizing the generative AI model to generate a plain-language insight summary of the data attributes and the corresponding attribute causes; and
providing, by the data analytics system, the visualization object and the plain-language insight summary within a user interface in response to the user query.
